(19) United States
(12) Patent Application Publication
(10) Pub. No.: US 2004/0267659 A1
(43) Pub. Date: Dec. 30, 2004

(54) Application of general instruments in a CSD

(76) Inventor: Jens Bache, Gentofte (DK)

Correspondence Address: NIXON & VANDERHYE, PC, 1100 N GLEBE ROAD, 8TH FLOOR, ARLINGTON, VA, 22201-4714, US

(21) Appl. No.: 10/602,006

(22) Filed: Jun. 24, 2003

(51) Int. Cl. G06F 17/60

(52) U.S. Cl. 705/38

(57) ABSTRACT

The invention refers to a method for use in a CSD-system when carrying out a corporate action in the CSD-system on a security or an instrument., the method comprising the following steps: retrieving information about the parameters for the corporate action, using said parameters, expressing the corporate action with an appropriate combination of predefined operating components, said components being a component that generates payments to participants in the system and/or a component that requests payment from participants in the system and/or a component that adds holdings to an account in the CSD-system (e.g. split or due to an acquisition) and/or a component that removes instruments from circulation in the CSD-system. (due to e.g. maturity etc), and executing the action according to the parameters and components that are included in the expressed action.

### TECHNICAL FIELD

The present application relates to a method and system for use in a so-called Central Securities Depository, commonly abbreviated as CSD.

### BACKGROUND ART

Traditionally, centralized financial infrastructure systems have been used mainly for storing gold or other assets, which belong to different nations in one and the same location. When transferring assets from one nation to another, all that needs to be done is to simply transfer assets from the account which belongs to the paying nation to the account which belongs to the nation that is to receive the payment.

As can be realized, the use of a centralized institution greatly facilitates the processing of payments, and for this reason, there has arisen an interest for using “CSD-like” systems for other commodities than gold, such as for example bonds and shares, and in principle for any kind of asset or instrument that can be imagined in the financial market, e.g. corporate bonds, warrants, etc.

Thus, in such an “expanded” centralized system, there would be a plethora of instruments. This facilitates for those using the system, e.g. issuers, brokers, banks, and not least, the operator of the system. Each instrument contained in such an expanded system is defined by a set of so called “events”, i.e. actions that can occur or be carried out for that particular instrument. The system as such could be referred to as a Centralized Securities Depository, abbreviated as CSD. Examples of existing CSD-type systems are the Frankfurter Kassenverein, DTC(New York), Sicovam (Paris) and Euroclear (Brussels)

According to contemporary knowledge or art, a particular set of events is defined for each type of instrument, each particular set being “tailor-made” for each type of instrument. A drawback with this is that with the large number of instrument types envisioned in future expanded CSD:s, there will be a need to create an equally large number of such sets of events. This will be cumbersome to handle, in addition to which, in different countries and markets, even for one and the same kind of instrument type, slightly different events may be used.

In conclusion, using conventional or contemporary art would mean that for each new market where one and the same CSD system is used, even if the instruments contained in it are also the same, an extensive amount of adaptation or tailoring has to be made. Also, for each new type of instrument that is added to the CSD-system, a new set of events has to be tailor-made for that instrument type.

### DISCLOSURE OF THE INVENTION

As has been describe and outlined above, there is a need for a method and a system by means of which it would be possible to reduce the amount of adaptations and tailoring of instruments to be made when adding a new type of instrument to an existing CSD, or when adding an existing CSD-system to a new market. The method and system should also be able to reduce the amount of work necessary when making amendments to an existing instrument in an existing or new CSD.

Much of the work necessary in the adaptations, tailoring and amendments which causes the above mentioned need is due to the fact that corporate actions have a wide variety of shapes and types, depending on the security or instrument in question and the creativity of the issuer of that instrument.

The need mentioned above is addressed by the present invention in that the invention discloses a method for use in a CSD-system when carrying out a so called corporate action, also sometimes referred to as asset servicing, in a CSD-system on a security or an instrument. Examples of corporate actions are payment of dividend or interest, splits or mergers. The method of the invention comprises the following steps:

retrieve information about the parameters for the corporate action, using said parameters, express the corporate action with an appropriate combination of predefined operating components, said components being chosen from the following group:

1. one component that generates payments to participants in the system

2. one component that requests payment from participants in the system

3. one component that adds holdings to an account in the CSD-system (e.g. split or due to an acquisition)

4. one component that removes instruments from circulation in the CSD-system. (due to e.g. maturity etc)

execute the action according to the parameters and components that are included in the expressed action.

The parameters which are retrieved in the first step are suitably amounts, numerals and dates, the numerals referring to, for example, account numbers in the CSD-system and related bank accounts, as well as numerals used in codes which identify individual securities or instruments in the system. The dates which are retrieved can, for example, be dates on which the components in the expression are to be used, or a date when the entire expression is to be carried out.

The invention also relates to a CSD-system in which use is made of such a method.

### BRIEF DESCRIPTION OF THE DRAWINGS

The invention will be described in more detail with reference to the appended drawings in which:

FIG. 1 shows building blocks according to the method of the invention, and

FIG. 2 shows a schematic flowchart of a method according to the invention.

### EMBODIMENTS

As mentioned earlier, each instrument contained in a CSD-system can be defined by the events which can be carried out on the instrument in question, or carried out as a function of the instrument in question.

The events which define an instrument can also be referred to as actions or “corporate actions”, terms which will also be used from now on in this text. For the sake of clarity, a number of instruments and corporate actions will be described below.

Each corporate action can be said to comprise the following three steps:

Preparation of the corporate action

Execution of the corporate action

Settlement of the corporate action

The first of the steps outlined above is the preparation of the corporate action. This step can be based on the contents of a database within the CSD and/or input from the issuer representative, “issuer representative” here being used as a generic term for the party in the CSD responsible for the instrument. (A participant or the CSD operator)

A purpose of the first step is to set up the components and parameters that guide the second step, the execution, or in other words to guide what is going to happen to the holdings of the instrument in question in the CSD.

The second of the steps is to execute the corporate action. This step runs through a record such as, for example, the CSD database of securities holdings and looks at all accounts in the CSD that hold the instrument in question. Each holding is identifies by a code—e.g. ISIN—ISIN being the ISO standard code: International Securities Identification Number.

For each account that holds the instrument in question, one or more “settlement obligations” are created (e.g. payments to the holders of the securities in question), based on the parameters set up in step 1.

Finally, in this step, one or more balancing settlement obligations for the issuer of the instrument is created, as well as any mandatory reports, i.e. suitably a transaction list for, inter alia, the issuer.

The third step is the settlement. Since this step is not a necessary part of the invention, the settlement step will not be described here. Also, this step can be carried out in a plurality of manners, which are well known to those skilled in the field.

In order to facilitate the understanding of the invention as well as the background to the invention, a number of examples will now be described, each example outlining a different instrument or action which can be comprised in an expanded CSD-system, as well as the events which define that particular instrument or action. Following those examples, an explanation will be given for each example regarding how the invention can be applied for the examples.

### EXAMPLE 1

### An Interest Payment

Consider what may be the simplest and most commonly known example of a financial transaction for a financial instrument: interest payment for a bond issue.

Assume that the parameters involved for the instrument in question are the following:

Interest: 5% per annum.

Smallest size: 100 USD

Total volume in circulation: 140,000,000 USD

Transaction date: Jun. 28, 2002

Due date: Jul. 1, 2002

The result of step 1, preparation, is: based on the holdings on June 28th, create a payment of 5 USD per one hundred, to be paid on July 1st from the issuer's cash record or holdings in the CSD.

Step 2, the execution of the event, would calculate the amount for each account in the CSD that exhibited the proper ISIN, and would then create a settlement obligation from the issuer to the account, for example to a bank account mentioned in the account.

In addition, in this step (step 2), the credit transactions will be netted per payment destination (e.g. bank), and the total amount will be checked against the total debit amount to the issuer and against the volume in circulation. In the present example, the total amount paid should be 7 million USD (5% of 140 million USD). This is reported to the issuer. Each bank (or other receiver of the payment) will receive a report containing the amount paid, and a transaction list containing the amount to be transferred to each investor's bank account.

Step 3 settles the settlement obligations on the due date after checking the cash on the issuer's cash record.

### EXAMPLE 2

### A Maturity Payment

This example will deal with the same instrument as above, but now to be fully repaid on July 1st.

The result of step 1 is: based on the holding on June 28, create a payment of 100 USD per one hundred to be paid on July 1st versus delivery of the securities. Step 2 calculates the amount for each account in the CSD-system, and creates a settlement obligation, i.e. an obligation to deliver the instruments to the issuer's account versus a payment from the issuer to the bank or banks mentioned in the accounts (as well as a transaction containing the payment to the bank account mentioned in the account).

The instruments are reserved on each account. Finally in this step, the credit payment transactions are netted per bank, and the total amount is checked against the total debit amount to issuer and against the volume in circulation.

In the present example the total amount paid should be 140 million USD (The full amount in circulation). This is reported to the issuer. The banks receive a report containing the amount paid, and a transaction list containing the amount to be transferred to each investor's bank account.

Step 3 settles the settlement obligations on the due date after checking the cash on the issuer's cash record.

### EXAMPLE 3

### Composite Corporate Actions

A decision by a user can result in a number of corporate actions in the CSD-system. In this case, the term “corporate event” will be used, one corporate event consisting of one or more corporate actions.

As an example of such a composite action or corporate event, assume an issuer in the CSD-system, company A, decides to carry out a split in which investors would receive one new share for every old share. The new shares will receive only half a dividend the first year, after which point in time the two types of shares would be identical.

Step 1: based on the holding, add new shares (new ISIN to the holding).

Step 2: for every holding, create a settlement obligation (issue free of payment) in the new ISIN.

Step 3: settle the obligations that add the new shares to all holdings.

After the first year—on a date specified by the issuer:

New step 1: for every ‘new share’: issue 1 ‘old share’ versus delivery of the ‘new share’.

New step 2: for every holding of new shares, create delivery versus delivery settlement obligation.

New step 3: settle the dvd (delivery versus delivery) obligations that merge old and new shares into one holding per account.

### EXAMPLE 4

### A corporate Action with Optional Elements

Some corporate actions involve an optional element for the investors using the CSD-system. One example of such an optional element would be that investors are given the possibility of choosing to receive bonus shares instead of being paid dividend.

Step 1, 2 and 3: For every holding of shares, add a right (a new ISIN since shares and rights are not identical) to the holding.

Give the investors a period to register their wishes on the rights. This can also be done through standing instructions, or by contacting the account controller.

Next step 1, 2 and 3: Generate payments or new shares based on the rights and the registered wishes.

A convertible bond is also an example of a security containing an element of choice.

Another example of such an optional element is a takeover bid: for every XYZ-Data share it will be possible for participants to choose to receive 1 “ABC-software” share+1000 USD.

### EXAMPLE 5

### Payment from the Investors

Company A decides to issue new capital through the existing shareholders. One new share will cost 107 USD.

Step 1, 2 and 3: For every holding of shares add a subscription night (new ISIN) to the holding. Give the investors a period to decide. They can sell the right or decide to accept the offer to buy new shares or they can simply ignore the offer.

New step 1, 2 and 3: For all investors that have accepted the offer: generate a delivery versus payment instruction to be settled via the clearing participant (in the CSD-system) chosen by the investor.

Examples 1-5 show different instruments which can be comprised in a CSD-system, and actions or composite actions (“events”) which may be performed on these instruments, or triggered by the instruments. These actions and events can all be carried out in contemporary systems, but traditionally corporate actions have been developed one by one. This has created quite a plethora of solutions—with the accompanying maintenance problems, as well as problems of following the speed of the market regarding developments of new instruments or amendments to existing ones.

It is the contention of the applicant of the present invention that any corporate action, and thus also any corporate event (i.e. composite action), can be broken down into a combination of four components or building blocks. Thus, in a CSD-system, it would be possible to define any corporate action by a combination of these four components or building blocks.

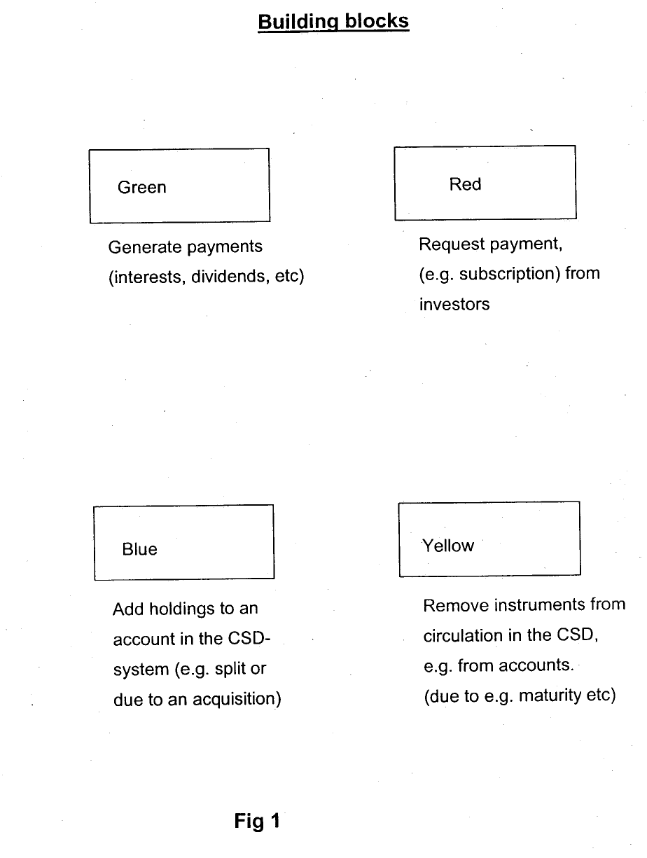

The four components of the invention are as follows, illustrated in FIG. 1 as well

“green” component—generate payments (interests, dividends, etc)

“red” component”—request payment (e.g. subscription) from investors

“blue component”—add holdings to an account in the CSD-system (e.g. split)

yellow” component—remove instruments from circulation in the CSD, e.g. from accounts. (due to e.g. maturity etc)

As will be realized, the names given to these four components/building blocks are more or less completely arbitrary. For example, the components might equally well be labeled “spinach”, “carrot”, “onion” and “cabbage”, as the operator or designer of the CSD-system sees fit.

Before presenting a general formula for the invention, involving the use of the four building blocks of the invention, some examples will now be shown of how the building blocks can be applied to the five corporate actions shown and described previously.

As stated above, each corporate action can be said to comprise the following three steps:

Preparation of the corporate action

Execution of the corporate action

Settlement of the corporate action

Essentially, it is the second step, i.e. the execution, which can be carried out by means of a combination of the building blocks. Using computer “pseudo-code” to express the second step, it would the be possible to express the second step of any corporate action in a manner similar to the following formula:

For every x of the proper ISIN do a*green+b*red+c*blue+d*yellow (1)

The parameters x, a, b, c, d, and the appropriate dates, ISIN:s and the account numbers in the CSD-system will have been set up in step 1. Step 1 can either be automated, i.e. carried out by an automatic process accompanying the CSD-system, or be set up manually by a user, e.g. the CSD staff or issuer representative. Suitably when using the method of the invention, step 1 is automated for commonly occurring actions, and is set up manually for actions which occur more rarely.

Thus, the degree of automation in step 1 for a certain corporate action will depend on how common that action is.

To illustrate the invention, the operations of examples 1-5 above will now be shown with the use of the building blocks of the invention. The examples will be shown under the assumption that that step 1 (“setting up”) has been automated and thus already has been carried out. The examples will be shown with pseudo-code.

### EXAMPLE 1′

### An Interest Payment Action with “the Building Blocks”

The first of the examples above of corporate actions involved an interest payment:

For every 100 of the proper ISIN, do 5% green

It will be recalled that “green” was the building block used for generating payments within the CSD-system, and thus it will be appreciated how the use of that particular building block fits in this particular action.

### EXAMPLE 2′

### A Maturity Payment Using “the Building Blocks”

The second of the examples given earlier dealt with the instrument from example 1 coming to maturity.

This can be expressed using the building blocks as:

For every 100 of the proper ISIN, do 100% green+100% yellow in the proper ISIN

The use of the green building block has been commented on previously, and will thus not be elaborated on further here. It will be recalled that the purpose or task of the yellow building block was to remove instruments from circulation in the CSD, e.g. from accounts. (due to e.g. maturity etc), which will explain the use of that building block in example 2′.

### EXAMPLE 3′

### Composite Corporate Actions Using the Building Blocks

It will be recalled that the example was that Company A decides a split: where investors receive one new share for every old share. The new shares receive only half dividend the first year. After this point the two types of shares are identical.

According to the invention:

For every 1 of ISIN2 do 1 blue in ISIN3

As described above, the blue building block is the block that adds holdings to an account.

When the dividend is to be paid during the first year (1.08 USD per year being half the dividend):

For every 1 of ISIN3, do 1.08 USD Green; since the green block is the one that generates payments.

The proper account numbers, ISIN identities etc are all obtained from step 1, i.e. the setting up, which is either automated or, if need be, done automatically by for example, the system operator.

After the first year:

For every 1 of ISIN3 do 1 blue in ISIN2+1 yellow in ISIN3,

i.e. the accounts receive shares that are identical to the original ones, and the “temporary” shares are nullified.

### EXAMPLE 4

### Optional Elements

Example 4 above involved an optional element, i.e. investors were given the possibility of choosing to receive bonus shares instead of being paid dividends.

In pseudo-code according to the invention:

For every 1 of ISIN2 do 1 blue in ISIN3

The investors are then given a period to register their wishes regarding the rights (“ISIN3”). Following said period, payments or new shares based on the rights and the registered wishes are generated, expressed in the following manner by means of the invention:

New shares:

For every 1 of ISIN3 do 1 blue in ISIN4+1 yellow in ISIN3

Payments:

For every 1 of ISIN3 do 2.17 USD green+1 yellow in ISIN3 i.e. 2.17 USD per share against delivery of the “dividend coupon”.

### EXAMPLE 5′

Example 5 above was that Company A decides to issue new capital through the existing shareholders. One new share will cost 107 USD. Expressed by means of the invention:

For every 1 of ISIN2 do 1 blue in ISIN3

Thus, for every holding of shares add a subscription right (new ISIN) to the holding, then give the investors a period to decide. They can sell the right, decide to accept the offer to buy new shares, or they can simply ignore the offer.

Accept the offer

For every 1 of ISIN3 do 1 blue in ISIN4+107 USD red+1 yellow in ISIN3

Ignore the offer:

For every 1 of ISIN3 do 1 yellow in ISIN3

Sell the rights:

Could be handled outside of the present CSD-system, as an ordinary trade in which 100 rights are sold at a price agreed upon.

Thus, by means of the invention, all so called corporate events (using the earlier given definition of that term) that can occur in an expanded CSD-type system can be defined in an extremely simple manner, as opposed to traditional methods for doing the same.

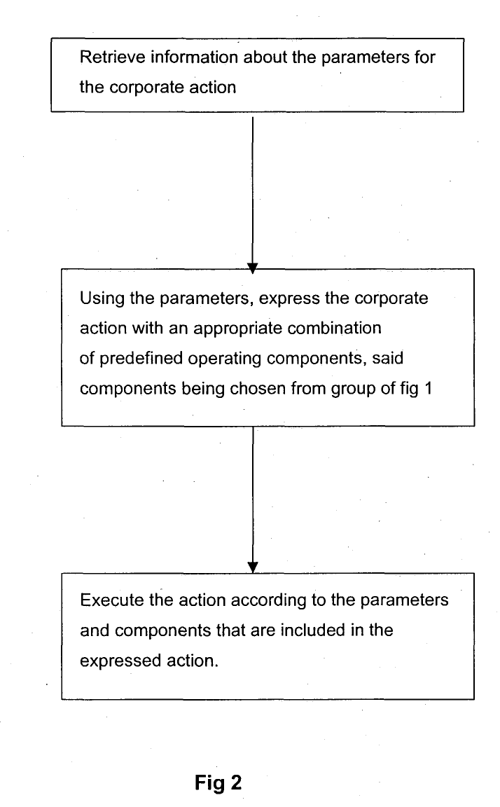

In order to additionally further the understanding of the invention, it could be said that an arbitrary type of corporate action in a CSD-type system using the method of the invention can be described in the following manner, as also shown in the flowchart in FIG. 2:

retrieve information about the parameters for the corporate action,

using said parameters, express the corporate action with an appropriate combination of predefined operating components, said components being chosen from the following group:

1. one component that generates payments to participants in the system

2. one component that requests payment from participants in the system

3. one component that adds holdings to an account in the CSD-system (e.g. split or due to an acquisition)

4. one component that removes instruments from circulation in the CSD-system. (due to e.g. maturity etc)

execute the action according to the parameters and components that are included in the expressed action.

The parameters which are retrieved in the first step are suitably amounts, numerals and dates, the numerals referring to, for example, account numbers in the CSD-system and related bank accounts, as well as numerals used in codes which identify individual securities or instruments in the system. The dates which are retrieved can, for example, be dates on which the components in the expression are to be used, or a date when the entire expression is to be carried out. The amounts retrieved can suitably refer to the securities or instruments used.

It should be pointed out that the first of the steps outlined above, i.e. the retrieval of parameters has been added in order to facilitate the understanding of the system according to the invention, and is not a step which needs to be comprised in a method or system according to the invention.

1. A method for use in a CSD-system when carrying out a corporate action in the CSD-system on a security or an instrument, the method comprising the following steps:
retrieving information about the parameters for the corporate action,
using said parameters, expressing the corporate action with an appropriate combination of predefined operating components, said components being chosen from the following group:
1. one component that generates payments to participants in the system
2. one component that requests payment from participants in the system
3. one component that adds holdings to an account in the CSD-system (e.g. split or due to an acquisition)
4. one component that removes instruments from circulation in the CSD-system. (due to e.g. maturity etc)
executing the action according to the parameters and components that are included in the expressed action.

2. The method of claim 1, in which one of the parameters which are retrieved is an amount which refers to a security or instrument used in the expression for the action.

3. The method of claim 1, in which one of the parameters which are retrieved is a numeral which refers to an account number in the CSD-system, a bank accounts or a code which identifies an individual security or instrument in the system.

4. The method of claim 1, in which one of the parameters which are retrieved is a date which is a date on which the components in the expression are to be used, or when the entire expression is to be carried out.

5. A computerized CSD-system for carrying out corporate actions on securities or instruments, the system comprising:
means for retrieving information about the parameters for the corporate action,
means for using said parameters, expressing the corporate action with an appropriate combination of predefined operating components, the system additionally comprising means for choosing said components from the following group:
1. one component that generates payments to participants in the system
2. one component that requests payment from participants in the system
3. one component that adds holdings to an account in the CSD-system (e.g. split or due to an acquisition)
4. one component that removes instruments from circulation in the CSD-system. (due to e.g. maturity etc)
executing the action according to the parameters and components that are included in the expressed action.

6. The system of claim 5, in which one of the parameters which are retrieved is an amount which refers to a security or instrument used in the expression for the action.

7. The system of claim 5, in which one of the parameters which are retrieved is a numeral which refers to an account number in the CSD-system, a bank accounts or a code which identifies an individual security or instrument in the system.

8. The system of claim 5, in which one of the parameters which are retrieved is a date which is a date on which the components in the expression are to be used, or when the entire expression is to be carried out.
